(19) United States
(12) Patent Application Publication
(10) Pub. No.: US 2022/0177017 A1
(43) Pub. Date: Jun. 9, 2022

(54) RUNNING APPARATUS AND TESTING APPARATUS

(71) Applicant: MITSUBISHI HEAVY INDUSTRIES MACHINERY SYSTEMS, LTD., Hyogo (JP)

(72) Inventors: Kenta YAMAMOTO, Hyogo (JP); Takuya YOSHIKAWA, Hyogo (JP); Ryohei UEHA, Hyogo (JP)

(21) Appl. No.: 17/430,701

(22) PCT Filed: Dec. 25, 2019
(86) PCT No.: PCT/JP2019/051021

§ 371 Date: Aug. 12, 2021

(30) Foreign Application Priority Data
Feb. 14, 2019 (JP) 2019-024804

(51) Int. Cl. B61L 27/04; B61B 13/00; B61L 25/02; G01M 17/08

(52) U.S. Cl. CPC B61L 27/04; B61B 13/00; G01M 17/08; B61L 25/025; B61L 25/021

(57) ABSTRACT

A running apparatus includes a rail, a bogie, and a control unit. The rail has a linear segment provided on a floor part, which is parallel to the horizontal plane, at least one curved segment connected to at least one end of the linear segment and curved upward from the linear segment, and an upright segment connected to the upper end of the curved segment and extending upward. The bogie includes a running unit capable of running on the rail. The control unit controls the running unit so that the bogie can run at a certain speed on the linear segment.

### FIELD

The present invention relates to a running apparatus and a testing apparatus.

### BACKGROUND

A running apparatus that drives a bogie by use of a drive source to run the bogie is known (see, for example, Patent Literature 1).

### CITATION LIST

### Patent Literature

Patent Literature 1: Japanese Patent Application Laid-open No. H08-239044

### SUMMARY

### Technical Problem

In recent years, it is needed to run a bogie at a high speed in running apparatus such as the one described above. However, securing large premises to install such a running apparatus is not easy in terms of management and expenses for the premises. Therefore, it is needed to run a bogie at a high speed in premises that are not very spacious.

The present invention has been made in consideration of the above situation, and an object of the present invention is to provide a running apparatus capable of running a bogie at a high speed in premises that are not very spacious.

### Solution to Problem

A running apparatus according to the present invention includes a rail having a linear segment and at least one curved segment, the linear segment being provided on a floor part arranged along a horizontal plane, the at least one curved segment being connected to at least one end of the linear segment and curved upward from the at least one end; a bogie including a running unit capable of running on the rail; and a control unit configured to control the running unit in such a manner that the bogie runs at a certain speed at least on the linear segment.

Therefore, the bogie that comes running from the linear segment on a forward path goes upward on the curved segment in a gravity-defying manner and then stops running. Thereafter, on a backward path, the bogie goes downward on the curved segment by gravity and then runs on the linear segment in a direction opposite to a direction taken in the forward path. Accordingly, the kinetic energy of the bogie that comes running from the linear segment is converted into and stored as potential energy on the curved segment, whereby the bogie can run in the opposite direction on the linear segment by having the potential energy converted into kinetic energy. Thus, even when the linear segment does not span a long distance, the bogie that runs on the linear segment in the opposite direction can run at a high speed, for example, if the bogie has been previously accelerated while being caused to go downward on the curved segment. A running apparatus capable of running a bogie at a high speed in premises that are not very spacious can be thus obtained.

Further, the curved segment may include two curved segments arranged on two respective opposite ends of the linear segment.

Therefore, on both sides of the linear segment, the kinetic energy of the bogie can be converted into potential energy and stored as the potential energy. Thus, the bogie can run at a higher speed by running forward and backward. In addition, when the bogie cannot be decelerated or braked in a normal manner although an attempt is being made to decelerate or brake the bogie, the bogie can be gradually decelerated by frictional force between the bogie and the rail by running forward and backward on both sides of the linear segment. Thus, the bogie can be prevented from colliding with a structure, such as a wall surface, surrounding the rail. Furthermore, the bogie can run forward and backward, which can make it easier to return the bogie to an initial position thereof after running the bogie from the initial position.

Further, the curved segment may be formed in such a manner that a curvature of the curved segment increases toward an upper side of the curved segment from the linear segment.

Therefore, when entering the curved segment from the linear segment, the bogie can be prevented from abruptly receiving force in a direction perpendicular to a direction in which the bogie runs.

Further, a displacement preventing unit may further be included that is arranged along the rail and configured to prevent the bogie from being displaced in a direction different from a direction in which the bogie runs. The bogie may further include a guide roller unit configured to rotate along the displacement preventing unit.

Therefore, the bogie can be prevented from being displaced in a direction different from the direction in which the bogie runs, whereby the state of running of the bogie can be stabilized.

Further, the guide roller unit may include an elastic part configured to receive force from the displacement preventing unit by elastic force.

Therefore, vibration of the bogie can be suppressed, whereby the state of running of the bogie can be stabilized.

Further, the displacement preventing unit may be provided along the entire rail.

Therefore, the state of running of the bogie can be stabilized on the entire rail.

Further, the displacement preventing unit may include a first guide part arranged along the rail and provided with a first guide surface arranged along the horizontal plane, and the guide roller part may include a first roller arranged under the first guide surface of the first guide part and configured to rotate along the first guide part.

Therefore, the bogie can be efficiently prevented from being displaced in a direction perpendicular to the surface on which to run of the rail, whereby the state of running of the bogie can be stabilized.

Further, the displacement preventing unit may include a second guide part arranged on the bogie and provided with a second guide surface perpendicular to the horizontal plane, and the guide roller part may include a second roller arranged on a side of the bogie with respect to the second guide part and configured to rotate along the second guide part.

Therefore, the bogie can be prevented from being displaced from one side to another in a direction perpendicular to a direction in which the bogie runs, whereby the state of running of the bogie can be stabilized.

Further, the rail may include an upright segment connected to an upper end of the curved segment and extending upward from the upper end of the curved segment.

Therefore, a region in which the kinetic energy of the bogie is converted into potential energy and is stored as the potential energy can be additionally provided to the upper side of the curved segment. Thus, even larger energy can be converted and stored.

Further, a detection sensor may further be included configured to detect a running state of the bogie.

Therefore, the running status of the bogie can be easily detected, whereby, for example, control using detection results is enabled.

Further, the detection sensor may include a speed sensor or a position sensor or both the speed sensor and the position sensor, the speed sensor being configured to detect the speed of the bogie, the position sensor being configured to detect when the bogie passes a certain position on the rail.

Therefore, the running status of the bogie and a position passed by the bogie can be easily detected, whereby, for example, control using detection results is enabled.

Further, the control unit may control, based on detection results of the detection sensor, the running unit to accelerate or decelerate the bogie on the linear segment.

Therefore, the running unit can be controlled according to the state of running of the bogie, whereby the state of running of the bogie can be adjusted with high precision.

Further, a building may further be included configured to house the rail and adjust a running environment for the bogie.

Therefore, the rail is housed in the building, and the running environment for the bogie is adjusted in the building, whereby the bogie can run in a desired running environment.

A testing apparatus according to the present invention includes the running apparatus described above; and a test object moving apparatus provided on the bogie and capable of, while holding a certain test object, moving the test object between a contact posture at which the test object makes contact with the floor part, and a separated posture at which the test object is separated from the floor part.

Therefore, a test object can be tested using the running apparatus capable of running the bogie at a high speed in premises that are not very spacious.

### Advantageous Effects of Invention

According to the present invention, a running apparatus and a testing apparatus that are capable of running a bogie at a high speed in premises that are not very spacious can be provided.

### BRIEF DESCRIPTION OF DRAWINGS

FIG. 1 is a front view illustrating an example of a running apparatus.

FIG. 2 is a plan view illustrating the example of the running apparatus.

FIG. 3 is a front view illustrating an example of a bogie.

FIG. 4 is a sectional view illustrating the example of the bogie.

FIG. 5 is a view illustrating an example of running behavior when the running apparatus is used.

FIG. 6 is a view illustrating an example of running behavior when the running apparatus is used.

FIG. 7 is a view illustrating an example of running behavior when the running apparatus is used.

FIG. 8 is a view illustrating an example of running behavior when the running apparatus is used.

FIG. 9 is a view illustrating an example of running behavior when the running apparatus is used.

FIG. 10 is a view illustrating an example of running behavior when the running apparatus is used.

FIG. 11 is a view illustrating a running apparatus according to a modification.

FIG. 12 is a view illustrating the running apparatus according to the modification.

FIG. 13 is a view illustrating a part of a running apparatus according to another modification.

FIG. 14 is a view illustrating an example of a testing apparatus.

### DESCRIPTION OF DRAWINGS

The following describes, based on the drawings, an embodiment of a running apparatus and a testing apparatus according to the present invention. This embodiment is not intended to limit this invention. Constituent elements in the following embodiment include those that are replaceable or easily conceivable by the skilled person or those that are substantially identical to each other.

In the present embodiment, directions in the drawings are explained using an XYZ coordinate system. In this XYZ coordinate system, a plane parallel to a floor part F, which is parallel to the horizontal plane, is defined as an XY plane. Directions in which a bogie 20 runs on this XY plane are referred to as X directions, and directions perpendicular to the X directions on the XY plane are referred to as Y directions. Directions perpendicular to the XY plane are referred to as Z directions. The following description assumes that a direction in which a corresponding arrow in each drawing points and a direction opposite to the foregoing direction are a positive direction and a negative direction of the X directions, respectively. The same applies to the Y directions and the Z directions.

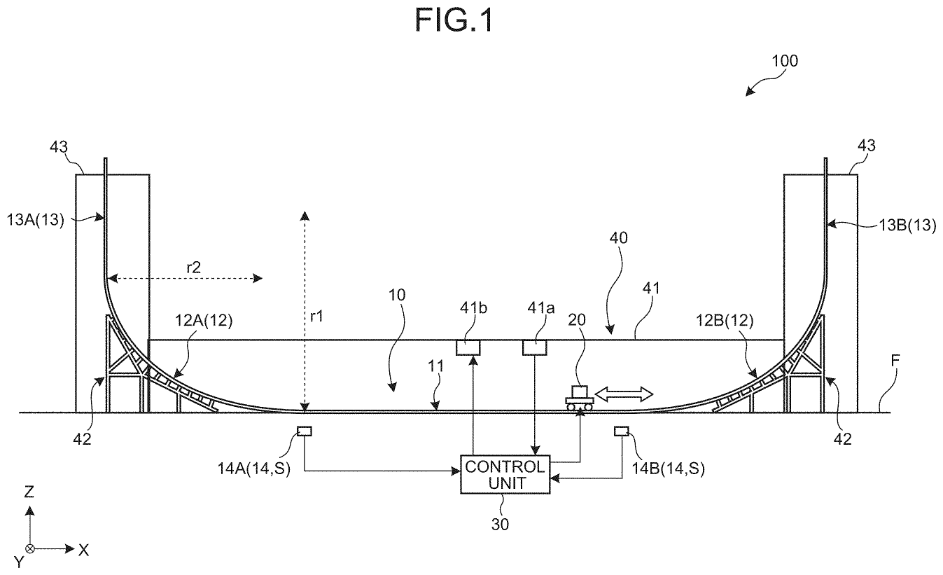

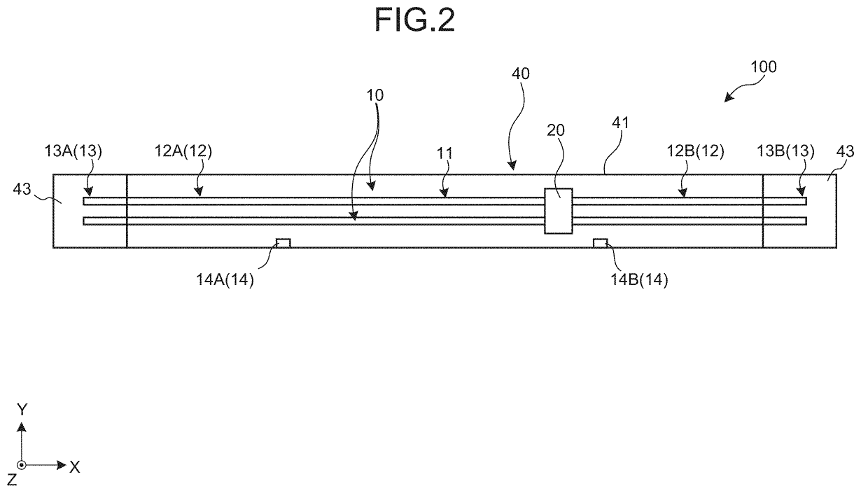

FIG. 1 is a front view illustrating an example of a running apparatus 100. FIG. 2 is a plan view illustrating an example of the running apparatus 100. As illustrated in FIG. 1 and FIG. 2, the running apparatus 100 includes at least one rail 10, a bogie 20, a control unit 30, and a building 40.

As the at least one rail 10, for example, two rails are arranged in parallel to each other in the Y directions. However, this is not a limiting example, and one rail is or three rails are arranged in the Y directions. Each of the rails 10 includes a linear segment 11, curved segments 12, upright segments 13.

The linear segment 11 is provided on the floor part F arranged along the horizontal plane. More specifically, the linear segment 11 is arranged within a recessed portion Fa of the floor part F parallel to the horizontal plane. The recessed portion Fa is provided with a bottom Fb and sides Fc. The bottom Fb is parallel to the floor part F. The linear segment 11 is supported by the bottom Fb and extends linearly in the X directions.

The curved segments 12 are connected to respective two opposite ends of the linear segment 11 and curved upward. The curved segments 12 include a first curved segment 12A and a second curved segment 12B. The first curved segment 12A is connected to one of the ends (for example, the left end thereof in FIG. 1 and FIG. 2) of the linear segment 11. The second curved segment 12B is connected to the other end (for example, the right end thereof in FIG. 1 and FIG. 2) of the linear segment 11. The first curved segment 12A and the second curved segment 12B have the same specifications as each other in terms of shape, dimensions, and the like except for being bilaterally symmetrically positioned. The following description denotes each of the first curved segment 12A and second curved segment 12B as the curved segment 12 when these curved segments are not distinguished from each other.

The upright segments 13 are connected to respective upper ends of the curved segment 12 and extend upward (for example, in the positive Z direction). The upright segments 13 may extend in a direction inclined with respect to the Z directions. The upright segments 13 include a first upright segment 13A and a second upright segment 13B. The first upright segment 13A is connected to the upper end of the first curved segment 12A. The second upright segment 13B is connected to the upper end of the second curved segment 12B. The first upright segment 13A and the second upright segment 13B have the same specifications as each other in terms of shape, dimensions, and the like except for being bilaterally symmetrically positioned. The following description denotes each of the first upright segment 13A and second upright segment 13B as the upright segment 13 these upright segments are not distinguished from each other.

The radius of curvature of the curved segment 12 gradually decreases toward a portion thereof connected to the upright segment 13 (where the radius of curvature is r2) from a portion thereof joined to the corresponding linear segment 11 (where the radius of curvature is r1). Therefore, the curved segment 12 is formed in such a manner that the curvature thereof increases toward the corresponding upright segment 13 from the linear segment 11.

The running apparatus 100 includes at least one position sensor 14. The position sensor 14 detects when the bogie 20 passes a certain position on the linear segment 11, the curved segment 12, and the upright segment 13 of each of the rails 10. The position sensor 14 is, for example, an optical sensor. The position sensor 14 can be configured to emit light for detection in the Y direction toward the track of the bogie 20 and detect changes in amount of the light emitted for detection. In this case, the amount of the light emitted for detection decreases when the bogie 20 blocks the light emitted for detection, which enables detection of when the bogie 20 passes. The position sensor 14 may be a sensor of a type other than the above.

The position sensor 14 can be arranged, for example, in a boundary portion between the linear segment 11 and the corresponding curved segment 12. The position sensors 14 include a position sensor 14 arranged on the first curved segment 12A side and a second position sensor 14B on the second curved segment 12B side. Each of the first position sensor 14A and the second position sensor 14B is denoted as the position sensor 14 when these position sensors are not differentiated from each other. Detection results of the position sensors 14 are transmitted to, for example, the control unit 30. The position sensor 14 may be arranged in a boundary portion between one of the curved segments 12 and the corresponding upright segment 13.

The running apparatus 100 includes a displacement preventing unit 15 (see some of the drawings such as FIG. 4). The displacement preventing unit 15 is arranged along the rails 10, and the displacement preventing unit 15, which is configured to prevent the bogie 20 from being displaced in a direction different from the direction in which the bogie 20 runs, includes first guide parts 16 and second guide parts 17.

The first guide parts 16 and the second guide parts 17 are provided along the rails 10. The first guide parts 16 are arranged on the bottom Fb of the recessed portion Fa of the floor part F. The second guide parts 17 are arranged to sides of the bogie 20 in the direction in which the bogie 20 runs. For example, the respective second guide parts 17 are arranged on sides Fc of the recessed portion Fa of the floor part F.

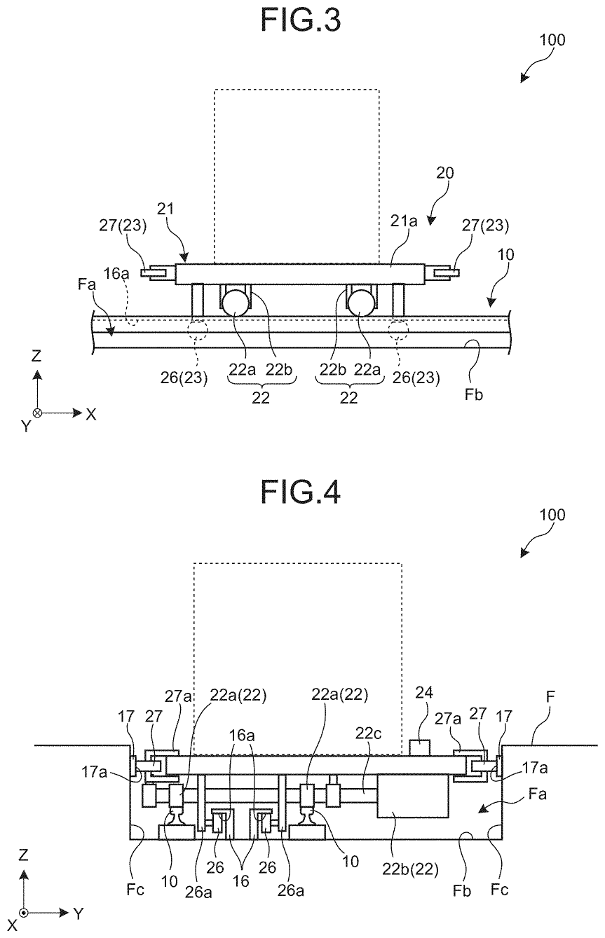

FIG. 3 is a front view illustrating an example of the bogie 20. FIG. 4 is a sectional view illustrating the example of the bogie 20. As illustrated in FIG. 3 and FIG. 4, the bogie 20 runs along the rails 10. The bogie 20 includes a main body part 21, a running units 22, a guide roller unit 23, and a speed sensor 24.

The main body part 21 includes a plate-like base member 21a arranged straddling the two rails 10. The main body part 21 supports the running unit 22, the guide roller unit 23, and the speed sensor 24.

The running unit 22 is capable of running along the rails 10. The running unit 22 includes running wheels 22a, drive units 22b, and a brake unit, which is not illustrated. The running wheels 22a project from the base member 21a toward the corresponding rails 10 and rotate on surfaces 10a on which to run of the corresponding rails 10. The surfaces 10a on which to run are portions of the rails 10 that face the running unit 22.

The drive unit 22b includes a drive source, such as a motor, and a transmission mechanism, such as a rotation axis 22c (see FIG. 4), that transmits drive power from the drive source to the running wheels. When the bogie 20 serves as the secondary side of a linear motor mechanism, a permanent magnet for example is provided in place of the drive unit 22b. When the bogie 20 serves as the primary side of a linear motor mechanism, a coil for example is provided as the drive unit 22b.

The guide roller unit 23 includes first rollers 26 and second rollers 27. Each of the first rollers 26 is arranged between the corresponding first guide part 16 and the bottom Fb. The first roller 26 rotates along the first guide surface 16a of the first guide part 16 that is a surface facing the bottom Fb. The first rollers 26 are coupled to the base member 21a via respective coupling members 26a. This configuration serves to effectively prevent the bogie 20 from being displaced in a direction perpendicular to the surfaces 10a on which to run of the rails 10, whereby the state of running of the bogie 20 can be stabilized. Each of the first rollers 26 may be supported by the corresponding coupling member 26a with an elastic member therebetween. In this case, an impact occurring between the first roller 26 and the first guide surface 16a of the corresponding first guide part 16 is absorbed by the elastic member, whereby the state of running of the bogie 20 can be further stabilized.

The second rollers 27 are arranged on two sides (one side facing in the positive Y direction and another side facing in the negative Y direction) of the bogie 20 opposite each other across the direction in which the bogie 20 runs. The second rollers 27 rotates along second guide surfaces 17a of the corresponding second guide part 17. The respective second guide surfaces 17a of the second guide parts 17 are arranged facing the inside of the recessed portion Fa. The second rollers 27 are coupled to the base member 21a via respective coupling members 27a. This configuration serves to effectively prevent the bogie 20 from being displaced from one side to another thereof across the direction in which the bogie 20 runs, whereby the state of running of the bogie 20 can be stabilized. One of the second rollers 27 that is arranged on one of the two sides opposite each other across the direction in which the bogie 20 runs may be supported by the corresponding coupling member 27a with an elastic member interposed therebetween. In this case, an impact occurring between the second roller 27 and the second guide surface 17a of the corresponding second guide part 17 is absorbed by the elastic member, whereby the state of running of the bogie 20 can be further stabilized.

The first guide parts 16 and the second guide parts 17 are provided along the entire rails 10. In the present embodiment, the first guide parts 16 and the second guide parts 17 are provided continuously along the entire linear segments 11, the entire curved segments 12, and the entire upright segments 13. The bogie 20 can be thus prevented from derailing from the curved segments 12 and the upright segments 13 when running on the curved segments 12 and the upright segments 13. In addition, because the first guide parts 16 and the second guide parts 17 are provided continuously along the entire linear segments 11, the entire curved segments 12, and the entire upright segments 13, the bogie 20 can run smoothly when running from the linear segments 11, the curved segments 12, or the upright segments 13 into the next segments.

The speed sensor 24 detects the running speed of the bogie 20. The speed sensor 24 can be attached to, for example, the base member 21a of the bogie 20. The speed sensor 24 may be attached to a different part of the bogie 20. Detection results of the speed sensor 24 are transmitted to, for example, the control unit 30.

The control unit 30 controls the state of running of the bogie 20. The control unit 30 controls the running unit 22 of the bogie 20, for example, in accordance with a computer program for running the bogie 20. In this case, the speed of the bogie 20 is adjusted by controlling the drive units 22b and the brake unit. Based on detection results of detection sensors such as the position sensor 14 and the speed sensor 24, the control unit 30 controls the running unit 22 so as to accelerate the bogie 20 on the linear segments 11. The bogie 20 can be highly precisely accelerated by being accelerated on the linear segments 11.

The building 40 houses the rails 10 and adjusts a running environment for the bogie 20. The building 40 includes a linear segment 41, curved-segment supporting segments 42, and upright segments 43. The linear segment 41 houses the linear segments 11 of the rails 10. The linear segment 41 includes an environment detecting sensor 41a and an environment adjusting unit 41b. The environment detecting sensor 41a detects the running environment for the bogie 20 in terms of, for example, the temperature and the humidity of the interior of the linear segment 41 and the dampness of the floor part F. The environment adjusting unit 41b adjusts the above running environment for the bogie 20 on the linear segments 41 based on detection results of the environment detecting sensor 41a.

The curved-segment supporting segments 42 are built, for example, on the floor part F and supports the curved segments 12 of the rails 10. By being supported by the curved-segment supporting segments 42, the curved segments 12 is enabled to receive centrifugal force from the bogie 20 without deforming. The upright segments 43 are provided in the Z directions along the upright segments 13 of the rails 10.

Accordingly, housing the rails 10 in the building 40 enables the running environment for the bogie 20 not to be affected by the weather, the temperature, the humidity, and the like of the outdoor and be set up independently thereof.

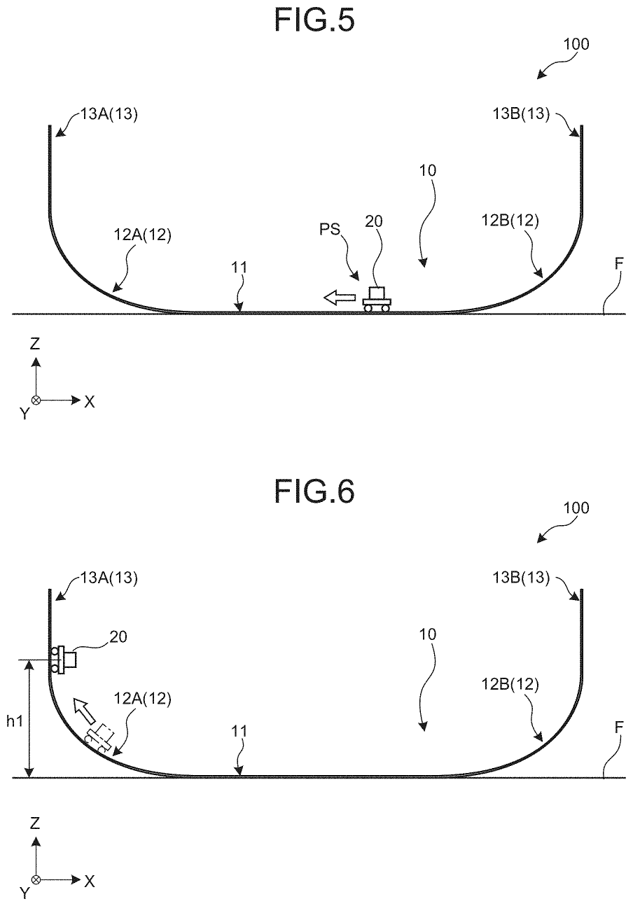

Next, running behavior when the running apparatus 100 configured as above is used is described. FIG. 5 to FIG. 10 are views illustrating examples of running behavior when the running apparatus 100 is used. First, the running environment inside the building 40 is adjusted into a certain environment. After the running environment is adjusted, the bogie 20 is placed at a certain initial position PS on the linear segments 11 as illustrated in FIG. 5. After the bogie 20 is placed, the control unit 30 runs the bogie 20 by controlling the running unit 22 of the bogie 20 at a certain timing. Based on detection results of sensors such as the speed sensor 24 mounted on the bogie and the position sensors 14 arranged along the rails 10, the control unit 30 adjusts the speed of the bogie 20. The control unit 30 accelerates the bogie 20 while the bogie 20 is running on the linear segments 11.

The bogie 20 that runs on the linear segments 11 enters the first curved segments 12A from the linear segments 11. The bogie 20 that has entered the first curved segments 12A makes a reversal movement when running on a range corresponding to the first curved segments 12A and the first upright segments 13A. In the reversal movement, the bogie 20 goes upward along the first curved segments 12A and first upright segments 13A in accordance with the size of kinetic energy calculated based on the gross mass and the speed of the bogie 20. While the bogie 20 runs upward along the first curved segments 12A and the first upright segments 13A, the kinetic energy of the bogie 20 is converted into energy such as potential energy. Once all of the kinetic energy 20 of the bogie 20 has been converted into energy such as potential energy, the bogie 20 stops running upward, for example, on the first upright segments 13A as illustrated in FIG. 6. Depending on the kinetic energy of the bogie, the bogie may stop when being in the middle of running on the first curved segment 12A. A height h1 of the position of the bogie 20 from the floor part F can be found based on the gross mass of the bogie 20 and the speed (kinetic energy) of the bogie 20 when the bogie 20 enters the first curved segments 12A. A part of the kinetic energy of the bogie 20 is converted into energy such as thermal energy due to friction between the rails 10 and the running unit 22 of the bogie 20; therefore, consideration is given to energy such as the thermal energy.

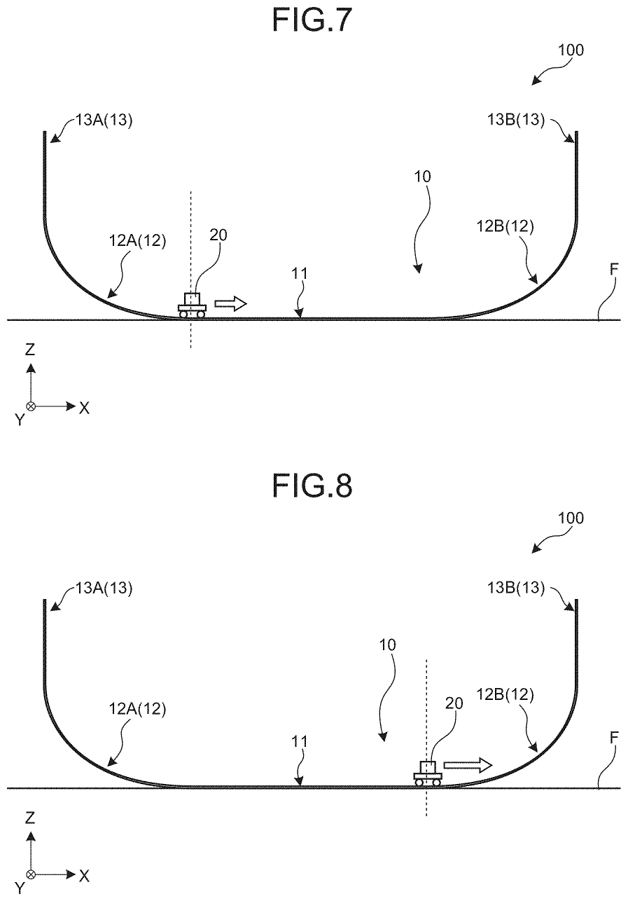

Once the bogie 20 has stopped, the control unit 30 does not accelerate the bogie 20. Thus, the bogie 20 goes downward along the first upright segments 13A and the first curved segments 12A by gravity. In this case, the first rollers 26 provided to the bogie 20 rotate on the first guide surfaces 16 of the first guide part 16 while being caught by the first guide surfaces 16. This prevents the bogie 20 from derailing from the rails 10 and enables the bogie 20 to run on the rails 10. The potential energy of the bogie 20 is converted into kinetic energy while the bogie 20 moves downward. As illustrated in FIG. 7, all of the potential energy of the bogie 20 is converted into kinetic energy until the bogie 20 reaches the linear segments 11.

The control unit 30 controls the state of running of the bogie 20 while the bogie 20 runs on the linear segments 11. For example, the control unit 30 accelerates the bogie 20 before the bogie 20 reaches a certain speed. Once the bogie 20 has reached a certain speed as a result, the control unit 30 controls the running speed of the bogie 20 so as to run the bogie 20 on the linear segments 11 at a constant speed.

In contrast, unless the bogie 20 has reached the certain speed, for example, at the arrival of the bogie 20 at the ends of the linear segments 11 (the ends facing in the positive X direction) as illustrated in FIG. 8, the control unit 30 causes the above direction reversal movement to be made again on the second curved segments 12B and the second upright segments 13B.

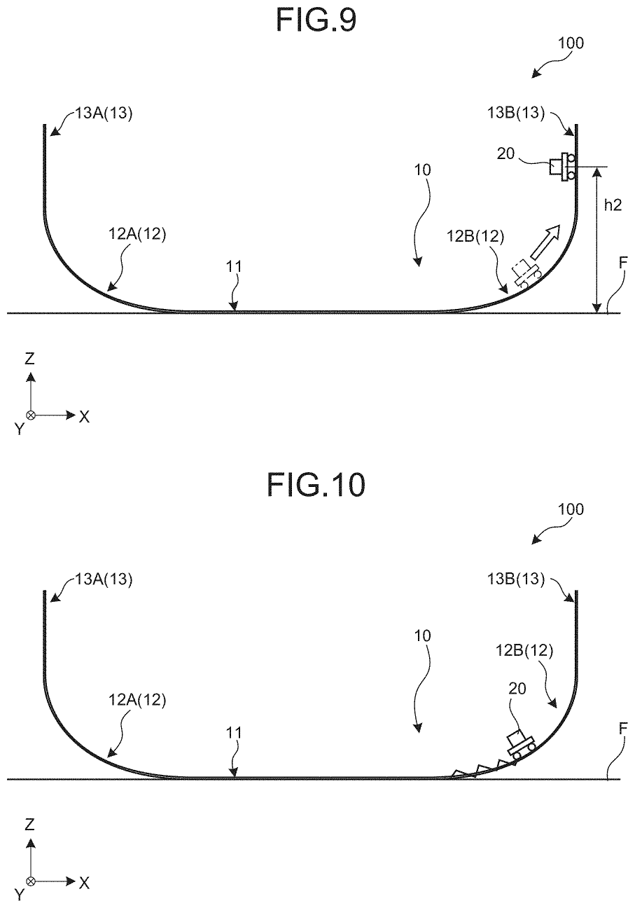

In this case, when making the direction reversal movement, the bogie 20 that has entered the second curved segments 12B runs upward along the second curved segments 12B in accordance with the size of kinetic energy calculated from the gross mass and the speed of the bogie 20. While the bogie 20 goes upward along the second curved segments 12B, the kinetic energy of the bogie 20 is converted into energy such as potential energy. Once all of the kinetic energy of the bogie 20 has been converted into energy such as potential energy, the bogie 20 stops running upward, for example, on the second upright segments 13B as illustrated in FIG. 9. A height h2 of the position of the bogie 20 from the floor part F can be found based on the gross mass of the bogie 20 and the speed (kinetic energy) of the bogie 20 when the bogie 20 enters the second curved segments 12B. The height h2 is larger than the height h1 at the time of the reversal movement made on the first curved segments 12A and the first upright segments 13A because the bogie 20 has been more accelerated on the linear segments 11.

Once the bogie 20 has stopped, the control unit 30 does not accelerate the bogie 20 in the same manner as described above. Thus, the bogie 20 is prevented from being derailed from the rails 10 and goes downward by gravity along the second upright segments 13B and the second curved segments 12B. The potential energy of the bogie 20 is converted into kinetic energy while the bogie 20 moves downward. All of the potential energy of the bogie 20 is converted into kinetic energy until the bogie 20 reaches the linear segments 11. The control unit 30 can further accelerate the bogie 20 while the bogie 20 thereafter runs on the linear segments 11 in the positive X direction. Accordingly, by making the reversal movement on the curved segments 12 and the upright segments 13, the bogie 20 can be accelerated on the linear segments 11 at the same time as running forward and backward on the linear segments 11. The bogie 20 can be thus accelerated easily to a desired speed even in an environment the space of which is limited in the length directions of the linear segments 11.

To stop the bogie 20, the control unit 30 decelerates the bogie 20 by using the brake unit. As illustrated in FIG. 10, when the bogie 20 is not decelerated to a desired speed even after entering the curved segments 12 from the linear segments 11, the bogie 20 can, by making the reversal movement on the curved segments 12 and the upright segments 13, be decelerated after the bogie 20 again reaches the linear segments 11. The bogie 20 can be thus prevented from, for example, colliding with another part even when being unable to be braked on a certain running zone.

As described above, the running apparatus 100 according to the present embodiment includes the rails 10, the bogie 20, and the control unit 30. Each of the rails 10 includes the linear segment 11 provided on the floor part F arranged along the horizontal plane, the curved segment or segments 12 connected to at least one of the two opposite ends of the linear segment 11 and curving upward, and the upright segment 13 connected to the upper end of the curved segment 12 and extending upward. The bogie 20 includes the running unit 22 capable of running on the rails 10. The control unit 30 controls the running unit 22 so as to run the bogie 20 at a certain speed on the linear segment 11.

Therefore, the bogie 20 that comes running from the linear segments 11 on a forward path goes upward on the curved segments 12 and the corresponding upright segments 13 in a gravity-defying manner and then stops running. Thereafter, on a backward path, the bogie goes downward on the curved segments 12 and the upright segments 13 by gravity and then runs on the linear segments 11 in a direction opposite to a direction taken in the forward path. Accordingly, the kinetic energy of the bogie 20 that comes running from the linear segments 11 is converted into and stored as potential energy on the curved segments 12 and the upright segments 13, whereby the bogie can run in the opposite direction on the linear segments 11 by having the stored potential energy converted into kinetic energy. Thus, even when the linear segments 11 do not span a long distance, the bogie 20 that runs on the linear segments 11 in the opposite direction can run at a high speed, for example, if the bogie 20 has been previously accelerated while being caused to go downward on the upright segments 13 and the curved segments 12. A running apparatus capable of running the bogie 20 at a high speed in premises that are not very spacious can be thus obtained.

In the running apparatus 100 according to the present embodiment, each of the linear segments 11 may have the curved segments 12 and the upright segments 13 arranged to the two opposite ends thereof.

Therefore, on both sides of the linear segments 11, the kinetic energy of the bogie 20 can be converted into potential energy and stored as the potential energy. Thus, the bogie 20 can run at a higher speed by running forward and backward. In addition, when the bogie 20 cannot be decelerated or braked in a normal manner although an attempt is being made to decelerate or brake the bogie 20, the bogie 20 can be gradually decelerated by frictional force between the bogie 20 and each of the rails 10 with the bogie 20 running forward and backward on both sides of the linear segments 11. Thus, the bogie 20 can be prevented from colliding with a structure, such as a wall surface, surrounding the rail. Furthermore, the bogie 20 can run forward and backward, which can make it easier to return the bogie 20 to the initial position PS after running the bogie from the initial position PS.

In the running apparatus 100 according to the present embodiment, each of the curved segments 12 may be formed in such a manner that the curvature thereof increases toward the upper side thereof from the linear segment 11.

Therefore, when entering the curved segments 12 from the linear segments 11, the bogie 20 can be prevented from abruptly receiving force in a direction perpendicular to a direction in which the bogie 20 runs.

In the running apparatus 100 according to the present embodiment, the displacement preventing unit 15 arranged along the rail 10 and configured to prevent the bogie 20 from being displaced in a direction different from the direction in which the bogie 20 runs may be further included, and the bogie 20 may include the guide roller unit 23 configured to rotate the displacement preventing unit 15.

The bogie 20 can be thereby prevented from being displaced in a direction different from the direction in which the bogie 20 runs, whereby the state of running of the bogie 20 can be stabilized.

In the running apparatus 100 according to the present embodiment, the guide roller unit 23 includes an elastic part configured to receive force from the displacement preventing unit 15 by elastic force.

Therefore, vibration of the bogie 20 can be suppressed, whereby the state of running of the bogie 20 can be stabilized.

In the running apparatus 100 according to the present embodiment, the displacement preventing unit 15 may be provided along the entire rails 10.

Therefore, the state of running of the bogie can be stabilized on the entire rails 10.

In the running apparatus 100 according to the present embodiment, the displacement preventing unit 15 may include the first guide parts 16, and the bogie 20 may include the first rollers 26. The first guide parts 16 is arranged along the rails 10 and provided with the first guide surfaces 16a arranged along a horizontal plane. The first rollers 26 is arranged under the first guide surfaces 16a of the first guide parts 16 and configured to rotate along the first guide part 16.

Therefore, the bogie 20 can be efficiently prevented from being displaced in a direction perpendicular to surfaces on which to run of the rails 10, whereby the state of running of the bogie 20 can be stabilized.

In the running apparatus 100 according to the present embodiment, the displacement preventing unit 15 may include the second guide parts 17 provided with the second guide surfaces 17a perpendicular to the horizontal plane to the bogie 20. The bogie 20 may have the second rollers 27 arranged on sides of the bogie 20 with respect to the second guide parts 17 and configured to rotate along the second guide parts 17.

Therefore, the bogie 20 can be efficiently prevented from being displaced from one side to another in a direction perpendicular to a direction in which the bogie 20 runs, whereby the state of running of the bogie 20 can be stabilized.

Each of the rails 10 may further include the upright segment 13 connected to the upper end of the curved segment 12 and extending upward from that upper end. A region in which the kinetic energy of the bogie 20 is converted into potential energy and is stored as the potential energy can be thereby further provided to the upper side of the curved segment 12. Even larger energy can be thus converted and stored.

In the running apparatus 100 according to the present embodiment, a detection sensor S configured to detect the running status of the bogie 20 may be further included.

Therefore, the running status of the bogie 20 can be easily detected, whereby, for example, control using detection results is enabled.

In the running apparatus 100 according to the present embodiment, the detection sensor S may include at least one of the speed sensor 24 configured to detect the speed of the bogie 20 and the position sensor 14 configured to detect when the bogie 20 passes a certain position on the linear segment 11, the curved segment 12, and the upright segment 13.

The speed of the bogie 20 and a position passed by the bogie 20 can be thereby detected easily, whereby, for example, control using detection results is enabled.

In the running apparatus 100 according to the present embodiment, the control unit 30 may, based on detection results of the detection sensor S, control the running unit 22 so as to accelerate the bogie 20 on the linear segments 11.

Therefore, the running unit 22 can be controlled according to the state of running of the bogie 20, whereby the state of running of the bogie 20 can be adjusted with high precision.

In the running apparatus 100 according to the present embodiment, the building 40 configured to house the rail 10 and adjust the running environment for the bogie 20 may be further included.

Therefore, the rails 10 are housed in the building 40, and the running environment for the bogie 20 is adjusted in the building 40, whereby the bogie 20 can run in a desired running environment.

The technical scope of the present invention is not limited by the above embodiment, and changes can be made to the above embodiment without departing from the gist of the present invention. For example, while the above embodiment is described using, as an example, a configuration in which the curved segments 12 and the upright segments 13 are arranged to the respective two opposite ends of each of the linear segments 11, this example is not limiting. For example, a configuration in which the curved segment 12 and the upright segment 13 are arranged to only one of these ends of the linear segment 11 may be applied alternatively.

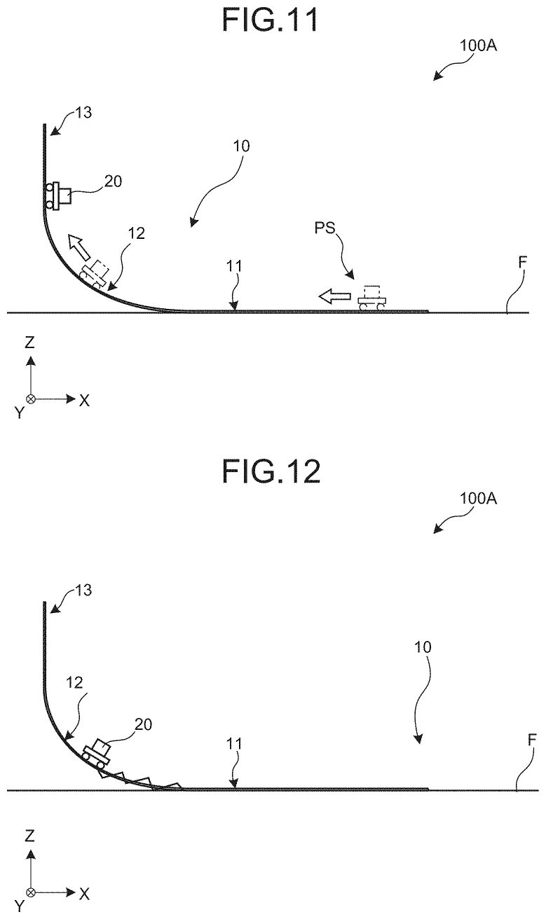

FIG. 11 and FIG. 12 are views illustrating a running apparatus 100A according to a modification. As illustrated in FIG. 11, for example, the bogie 20 that runs on the linear segment 11 while being accelerated enters the first curved segments 12A from the linear segments 11. The bogie 20 that has entered the first curved segments 12A makes a reversal movement on the first curved segments 12A and the first upright segments 13A. After the bogie 20 reaches the linear segments 11 after making the reversal movement, the control unit 30 can further accelerate the bogie 20.

The same descriptions as in the above embodiment can be applied to operation of braking the bogie 20. That is, as illustrated in FIG. 12, when the bogie 20 is not decelerated to a desired speed even after entering the curved segments 12 from the linear segments 11, the bogie can, by making the reversal movement on the curved segments 12 and the upright segments 13, be decelerated after the bogie 20 again reaches the linear segments 11.

Accordingly, even when the curved segment 12 and the upright segment 13 are arranged to only one of the two opposite ends of each of the linear segments 11, the bogie can, by making the reversal movement on the curved segments 12 and the upright segments 13, be accelerated or decelerated on the linear segments 11 at the same time as running forward and backward on the linear segments 11. Thus, the bogie 20 can be accelerated easily even in an environment the space of which in the length directions of the linear segments 11 is limited. Furthermore, the bogie 20 can be prevented from, for example, colliding with another part even when being unable to be braked on a certain running zone.

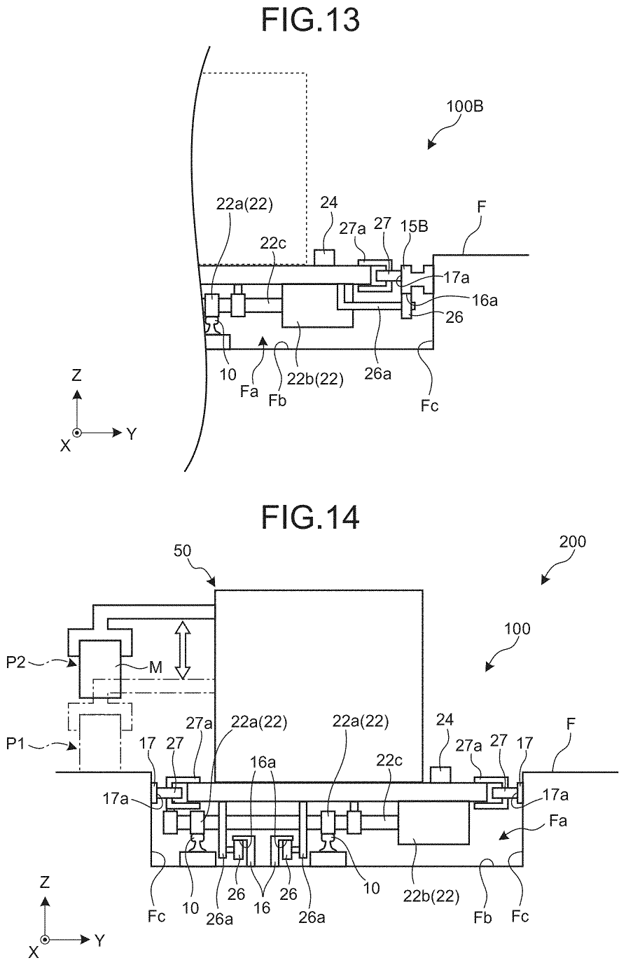

Although the above embodiment is described using, as an example, a configuration in which, while the first guide parts 16 of the displacement preventing unit 15 are arranged on the bottom Fb of the recessed portion Fa, the second guide parts 17 thereof are arranged on the sides Fc of the recessed portion Fa, this example is not limiting. FIG. 13 is a view illustrating a part of a running apparatus 100B according to another modification. As illustrated in FIG. 13, a configuration in which a guide part 15B obtained by integrating the first guide part 16 and the second guide part 17 is arranged on the side Fc may be applied alternatively. Thus, the first roller 26 arranged under the first guide part 16 and the second roller 27 arranged along the second guide surface 17a of the second guide part 17 can be integrally arranged. The configurations inside the recessed portion Fa are compactly provided.

Furthermore, each of the running apparatuses 100, 100A, and 100B described above can be used as a testing apparatus. FIG. 14 is a front view illustrating an example of a testing apparatus 200. As illustrated in FIG. 14, the testing apparatus 200 is configured by, for example, mounting a test object moving apparatus 50 on the bogie 20 of the running apparatus 100, 100A, or 100B. The test object moving apparatus 50 can, while holding a test object M, move a test object M between a contact position P1, at which the test object moving apparatus 50 takes a contact posture for placing the test object M in contact with the floor part F, and a separated position P2, at which the test object moving apparatus 50 takes a separated posture for separating the test object M from the floor part F. The testing apparatus 200 can swing the test object M on the contact position P1 by placing the test object M on the floor part F while the bogie 20 is running.

The control unit 30 is capable of controlling the moving behavior of the test object M using the test object moving apparatus 50. The control unit 30 is capable of controlling the test object moving apparatus 50, for example, so that the test object M can be moved to the contact position P1 while the bogie 20 runs on the linear segments 11. The control unit 30 is further capable of controlling the test object moving apparatus 50, for example, so that test object M can be moved from the contact position P1 to the separated position P2 before the bogie 20 enters the curved segments 12 from the linear segments 11.

Accordingly, the control unit 30 can control the state of running of the bogie 20 and the position of the test object M while coordinating the state of running of the bogie 20 and the position of the test object M with each other. Specific controlling of the state of running of the bogie 20 and the position of the test object M is not limited to the above described controlling. The control unit 30 is capable of controlling the test object moving apparatus 50, for example, so that the test object M can be moved to the contact position P1 while the bogie 20 runs on curved segments 12 or the upright segments 13.

As described above, the testing apparatus 200 according to the present embodiment includes the above running apparatus 100, 100A, or 100B and the test object moving apparatus 50 that is provided on the bogie 20 and capable of, while holding a certain test object M, moving the test object M between the contact position P1 at which the test object M makes contact with the floor part F, and the separated position P2 at which the test object M is separated from the floor part F. Therefore, a test object can be tested using the running apparatus 100, 100A, or 100B capable of running the bogie 20 at a high speed in premises that are not very spacious.

### REFERENCE SIGNS LIST

10 RAIL
10a SURFACE ON WHICH TO RUN
11 LINEAR SEGMENT
12 CURVED SEGMENT
12A FIRST CURVED SEGMENT
12B SECOND CURVED SEGMENT
13 UPRIGHT SEGMENT
13A FIRST UPRIGHT SEGMENT
13B SECOND UPRIGHT SEGMENT
14 POSITION SENSOR
14A FIRST POSITION SENSOR
14B SECOND POSITION SENSOR
15 DISPLACEMENT PREVENTING UNIT
15B GUIDE PART
16 FIRST GUIDE PART
16a, 17a GUIDE SURFACE
17 SECOND GUIDE PART
20 BOGIE
21 MAIN BODY PART
21a BASE MEMBER
22 RUNNING UNIT
22a RUNNING WHEEL
22b DRIVE UNIT
22c ROTATION AXIS
23 GUIDE ROLLER UNIT
24 SPEED SENSOR
26 FIRST ROLLER
26a, 27a COUPLING MEMBER
27 SECOND ROLLER
30 CONTROL UNIT
40 BUILDING
41 LINEAR SEGMENT
41a ENVIRONMENT DETECTING UNIT
41b ENVIRONMENT ADJUSTING SENSOR
42 CURVED-SEGMENT SUPPORTING SEGMENT
43 UPRIGHT SEGMENT
50 TEST OBJECT
100, 100A, 100B RUNNING APPARATUS
200 TESTING APPARATUS
F FLOOR PART
M TEST OBJECT
P1 CONTACT POSITION
P2 SEPARATED POSITION
PS INITIAL POSITION
S DETECTION SENSOR
Fa RECESSED PORTION
Fb BOTTOM
Fc SIDE

1. A running apparatus comprising:
a rail having a linear segment and two curved segments, the linear segment being provided on a floor part arranged along a horizontal plane, the two curved segments being connected to respective opposite ends of the linear segment and curved upward from the ends;
a bogie including a running unit capable of running on the rail; and
a control unit configured to control the running unit in such a manner that the bogie runs at a certain speed at least on the linear segment, wherein
the rail includes an upright segment connected to an upper end of the curved segment and extending upward from the upper end of the curved segment,
the curved segment is formed in such a manner that a curvature of the curved segment increases toward an upper side of the curved segment from the linear segment, and
the control unit controls the running unit in such a manner that the bogie enters one of the curved segments or the upright segment from the linear segment, reverses on the one of the curved segments or the upright segment, does not accelerate or decelerate on the upright segment, and enters the linear segment again to accelerate so as to increase the speed of the bogie or enters the linear segment again to decelerate so as to reduce the speed of the bogie.

2. (canceled)

3. (canceled)

4. The running apparatus according to claim 1, further comprising a displacement preventing unit arranged along the rail and configured to prevent the bogie from being displaced in a direction different from a direction in which the bogie runs, wherein
the bogie further includes a guide roller unit configured to rotate along the displacement preventing unit.

5. The running apparatus according to claim 4, wherein the guide roller unit includes an elastic part configured to receive force from the displacement preventing unit by elastic force.

6. The running apparatus according to claim 4, wherein the displacement preventing unit is provided along the entire rail.

7. The running apparatus according to claim 4, wherein
the displacement preventing unit includes a first guide part arranged along the rail and provided with a first guide surface arranged along the horizontal plane, and
the guide roller part includes a first roller arranged under the first guide surface of the first guide part and configured to rotate along the first guide part.

8. The running apparatus according to claim 4, wherein
the displacement preventing unit includes a second guide part arranged on the bogie and provided with a second guide surface perpendicular to the horizontal plane, and
the guide roller part includes a second roller arranged on a side of the bogie with respect to the second guide part and configured to rotate along the second guide part.

9. (canceled)

10. The running apparatus according to claim 1, further comprising a detection sensor configured to detect a running state of the bogie.

11. The running apparatus according to claim 10, wherein the detection sensor includes a speed sensor or a position sensor or both the speed sensor and the position sensor, the speed sensor being configured to detect the speed of the bogie, the position sensor being configured to detect when the bogie passes a certain position on the rail.

12. The running apparatus according to claim 10, wherein, based on detection results of the detection sensor, the control unit controls the running unit to accelerate or decelerate the bogie on the linear segment.

13. The running apparatus according to claim 1, further comprising a building configured to house the rail and adjust a running environment for the bogie.

14. A testing apparatus comprising:
the running apparatus according to claim 1; and
a test object moving apparatus provided on the bogie and capable of, while holding a certain test object, moving the test object between a contact posture at which the test object makes contact with the floor part, and a separated posture at which the test object is separated from the floor part.
